(19) United States
(12) Patent Application Publication
(10) Pub. No.: US 2008/0222423 A1
(43) Pub. Date: Sep. 11, 2008

(54) SYSTEM AND METHOD FOR PROVIDING SECURE AUTHENTICATION OF DEVICES AWAKENED FROM POWERED SLEEP STATE

(75) Inventors: Felipe Rodriguez, Luzern (CH); Robert Duda, Linz (AT)

Correspondence Address: OSTROLENK FABER GERB & SOFFEN, 1180 AVENUE OF THE AMERICAS, NEW YORK, NY, 100368403, US

(73) Assignee: SECUDE INTERNATIONAL, Cham (CH)

(21) Appl. No.: 12/043,667

(22) Filed: Mar. 6, 2008

Related U.S. Application Data
(60) Provisional application No. 60/893,292, filed on Mar. 6, 2007.

(51) Int. Cl. H04L 9/32

(52) U.S. Cl. 713/182

(57) ABSTRACT

In one embodiment, a system wake-up vector points to a native OS wake-up routine. As the native OS awakens from sleep it passes the wake-up message to the appropriate device drivers. A hardware device whose security context to be restored hooks the appropriate driver in order to intercept and handle the wake-up message. In a second embodiment, a system wake-up vector is redirected to a device specific S3 wake-up subroutine that handles a resume from S3 prior to allowing the call of the native OS wake-up vector. This S3 wake-up subroutine challenges a user for authentication credentials or retrieves them from a hardware device. The supplied credentials are used directly or to decrypt an unlock key from an encrypted key in memory. The unlock key would then be used to unlock the hardware device or fed to the native OS for processing by a device driver capable of unlocking the hardware device.

### CROSS-REFERENCE TO RELATED APPLICATION

This application is based on and claims priority to U.S. Provisional Patent Application Ser. No. 60/893,292, filed on Mar. 6, 2007 and entitled SYSTEM AND METHOD FOR PROVIDING SECURE AUTHENTICATION OF DEVICES AWAKENED FROM POWERED SLEEP STATE, the entire contents of which is hereby incorporated by reference.

### BACKGROUND

1. Field

The present invention relates generally to computer hardware and software security, and, more particularly, to authentication of computing devices.

2. Description of the Related Art

Computer hardware devices, which restrict access but are needed by the host operating system upon awakening from a powered sleep state, require a secure mechanism by which the user can re-authenticate his credentials before access to such a privileged device is granted. The problem is common on portable computers where sleep states such as the ACPI defined S3 can for maximum efficiency be implemented to remove all power from a storage or networking device, thereby, resulting in the loss of the pre-sleep authentication context. Similar requirements arise on computer hardware where sleep states do not completely power down the device given that the native operating system may not be secure and thus its native authentication cannot be trusted.

In order to preserve power and/or computing resources, computing systems can be instructed to enter a “sleep mode” and essentially become deactivated after a period of time, and do not awaken until some event occurs. Typically, such an event occurs when a user attempts to perform some operation. The computer hardware device, such as the drive, may be required by the operating system for fulfillment of the respective operation.

Various sleep modes are known in the art. For example, in S1 Standby a computing device appears off. In S1 sleep, the device's central processing unit (“CPU”) is stopped, although the devices random access memory (“RAM”) is refreshed and the computer system operates in a low power mode. In S2 sleep, the computer system appears off, the CPU has no power however RAM is refreshed. In S2 mode, the computer system operates in a lower power mode than S1 sleep mode. In S3 sleep mode, the computer system appears off, the CPU has no power and RAM is refreshed. Also in S3 sleep mode, the power supply operates in a reduced power mode. At S4 sleep mode, the system is in a “hibernate” mode, and appears off. The device's hardware is off, and system memory is saved in a temporary file stored on the device's hard disk. At S5 sleep mode, the system is completely powered down and off. Typically, an internal battery enables the clock active.

As known in the art, a computer hardware device, such as a drive, may restrict access and yet still be needed by a host operating system. Typically, security is provided in connection with the device that requires a user's authentication in order for the user (and, accordingly, the operating system) to access the device.

Unfortunately, and as known in the prior art, after a host operating system enters sleep mode, a user's authentication to access a device is lost when the operating system makes a call to the device's device driver upon being awakened. Even though a particular device (e.g., the drive) may be required by the computer's host operating system upon awakening from a powered sleep state, no secure mechanism enabling a user to re-authenticate his credentials is known in the art. This presents a problem for users who routinely experience connectivity problems with devices that have lost respective authentication following sleep-mode. As used herein, the device is considered “locked” when access to the operating system is not available.

For example, the problem is common on portable computers where sleep states such as the Advanced Configuration and Power Interface (“ACPI”) known S3 (e.g., “Standby,” “Sleep,” or “Suspend to RAM) can for maximum efficiency be implemented to remove all power from a storage or networking device, thereby, resulting in the loss of the pre-sleep authentication context. Similar requirements arise on computer hardware where sleep states do not completely power down the device given that the native operating system may not be secure and thus its native authentication cannot be trusted.

### SUMMARY

Accordingly, and in a preferred embodiment, a secure mechanism is provided by which a user can re-authenticate his credentials before access to such a privileged device is granted.

In one embodiment, a system wake-up vector points to a native OS wake-up routine. As the native OS awakens from sleep it passes the wake-up message to the appropriate device drivers. A hardware device whose security context to be restored hooks the appropriate driver in order to intercept and handle the wake-up message. In a second embodiment, a system wake-up vector is redirected to a device specific S3 wake-up subroutine, which handles a resume from S3 prior to allowing the call of the native OS wake-up vector. This S3 wake-up subroutine challenges a user for authentication credentials or retrieves them from a hardware device. The supplied credentials are used directly or to decrypt an unlock key from an encrypted key in memory. The unlock key is then be used immediately to unlock the hardware device or fed to the native OS for processing by a device driver capable of unlocking the hardware device.

Accordingly, a system and method is disclosed for providing secured access to a locked device. In one embodiment, the device is unlocked a first time by using authentication that represents security credentials for accessing the device. Accordingly, a security context is provided. Thereafter, the security context is lost and the device is locked. In one embodiment, the security context is lost when the device enters S3 sleep mode. The device is, thereafter, unlocked a second time using the authentication after the device loses the security context.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrate functional elements associated with an example computing device;

FIG. 2A is a block diagram that illustrates an example device driver stack in accordance with an embodiment;

FIG. 2B is a block diagram that illustrates an example device driver stack in accordance with another embodiment;

FIG. 3 is a flow chart that illustrates example steps associated with an embodiment; and

FIG. 4 is a flow chart that illustrates example steps associated with another embodiment.

### DESCRIPTION OF THE EMBODIMENTS

In accordance with the teachings herein, various authentication techniques are envisioned to utilize a special purpose authentication driver which connects, or “hooks” as known in the art, into either a firmware's wake-up process (e.g., vector) or a native OS device driver, in order to restore a respective security context of a particular hardware device. In a preferred embodiment, a secure mechanism is provided by which a user re-authenticates his credentials before authorization to access a privileged device is granted. Depending on a particular computer system, the hooking operation may occur dynamically at runtime, during installation, at boot time or at compile time, as known in the art. In the case of a MICROSOFT WINDOWS operating system operating on a computer system, one embodiment includes a filter driver that is a part of the device driver stack. Preferably, the special purpose driver intercepts the system's message, “resume from sleep” and performs one or more of the following steps: transparently authenticate the user to the device based on memory resident authentication credentials, challenge the user for authentication credentials, acquire authentication credentials from a hardware device, such as a smart card, hardware dongle, or the like, or a combination thereof while simultaneously relying on the native operating system graphical user interface (“GUI”) authentication mechanism.

In a preferred embodiment, a secure mechanism is provided by which a user re-authenticates his credentials before access to a device is granted. In a preferred embodiment, secured access to a device is enabled that, due to some event resulting in termination of an authorized and secured use of the device, conveniently and securely restores a given security context of the device was in place prior to occurrence of the event. For example, a hardware device operating securely (i.e., is unlocked) effectively forgets that it is unlocked once power is removed from the device. When power is restored, the device resumes operation in a locked mode. In another example, an unlocked hard drive operating securely in a laptop computer hard drive loses its security context when a user closes the lid of the laptop, thereby placing the drive in a sleep mode. The device forgets it is unlocked, and resumes operation in a locked mode.

As used herein, the term, “module,” refers, generally, to one or more discrete components that contribute to the effectiveness of the teachings herein. Modules can include software elements, including but not limited to functions, algorithms, classes and the like. Modules also include hardware elements, substantially as described below. Modules can operate independently or, alternatively, depend upon one or more other modules in order to function.

In accordance with one example embodiment, upon awakening from a powered sleep state, a native operating system signals its hardware device drivers so that drivers are operable to awaken respective hardware devices. Several authentication techniques for the respective devices are provided herein, each of which preferably utilizes a special purpose authentication driver that hooks into the operation of a hardware device driver in order to securely authenticate access to device. The device may be, for example, a storage or networking device, and is preferably authenticated when the operating system signals a device driver to resume operation following a sleep mode.

As noted above, depending on a particular native operating system, the hooking operation may occur dynamically at runtime, during installation or at compile time. For example, in case of a MICROSOFT WINDOWS operating system environment, one embodiment includes an implementation with a filter driver, which preferably becomes a part of the device driver stack. In accordance with a preferred embodiment, the most secure implementations of the special purpose driver preferably authenticate by executing applications stored on the device in need of authentication or by displaying a dynamically generated authentication GUI, the contents of which are provided from the device in need of authentication.

In accordance with one example embodiment including a computer operating the MICROSOFT WINDOWS XP operating system, a device driver is hooked into an operating system that operates in connection with the operating system's native authentication procedures, such as a graphical identification and authentication (“GINA”) or MICROSOFT VISTA CREDENTIAL PROVIDERS that provides secure authentication and interactive logon services.

In a preferred embodiment and during a process of locking a device, such as a disk drive, a device key is generated and used, such as during a hard disk pre-boot authentication environment during a normal boot-strap process, to unlock the hardware device. While the hardware device remains in an active state and not powered off or suspended in a sleep mode, the hardware device is unlocked and available.

Continuing with this example embodiment, one or more modules operate to perform operations on the key, to prevent the key from being detected or accessed. For example, the key is made inaccessible by obfuscation or other suitable technique that causes the key to appear unintelligible, or otherwise precludes the key from being detected by unscrupulous users, such as hackers. For example, an XOR technique is performed on the key, thereby rendering the key unintelligible to outsiders.

Thereafter, when the security context of the hardware device is affected, for example, by a removal of power, the device resumes a locked mode of operation. In accordance with this example embodiment, upon awakening the device or otherwise accessing it, the obfuscated key is substantially automatically unobfuscated and accessed to unlock the device, thereby enabling the device to resume to active operation, including to re-authenticate a user via the operating system's native authentication procedure(s).

In accordance with this example embodiment, the device is preferably locked in case a user fails to submit correction credentials (e.g., user name and password) during a process to re-authenticate the user after the security context of the device is lost. Alternatively, if the user submits proper credentials, then the device is active and available for use.

Thus, as described in the above example embodiment, an operating system “hook” is used for unlocking devices and locking devices in conjunction with operating system's native authentication procedures.

In an alternative embodiment, upon operating in a state in which a security context is lost, such as awakening from a powered sleep state, an authentication process hooks into either a firmware wake-up vector as opposed to a native OS device driver in order to restore the security context of the hardware device. In this alternative embodiment, an authentication process, such as to receive a user name and password from a user, is provided that is preferably not part of the native operating system. In this embodiment and unlike the previously described example embodiment, no unlocking of the hardware device (e.g., full disk encryption (“FDE”) hard disk drive) is necessary to authenticate a user. In the previously described example embodiment, the device is unlocked in order for the operating system authentication process (e.g., GINA) to function. In the present example, no unlocking is necessary because the authentication process is hooked directly to the device's firmware, such as in an ACPI wakeup vector.

Continuing with this alternative embodiment, the device key is not obfuscated (described above) and is, instead, encrypted. Preferably, a user is prompted for authentication (or authentication is retrieved from a device) via a non-operating system authentication process, and when proper credentials are received, a (second) symmetric key is preferably used to decrypt the encrypted key for unlocking the device. In one embodiment, the symmetric key is fixed within code that is hooked with the firmware wake-up vector.

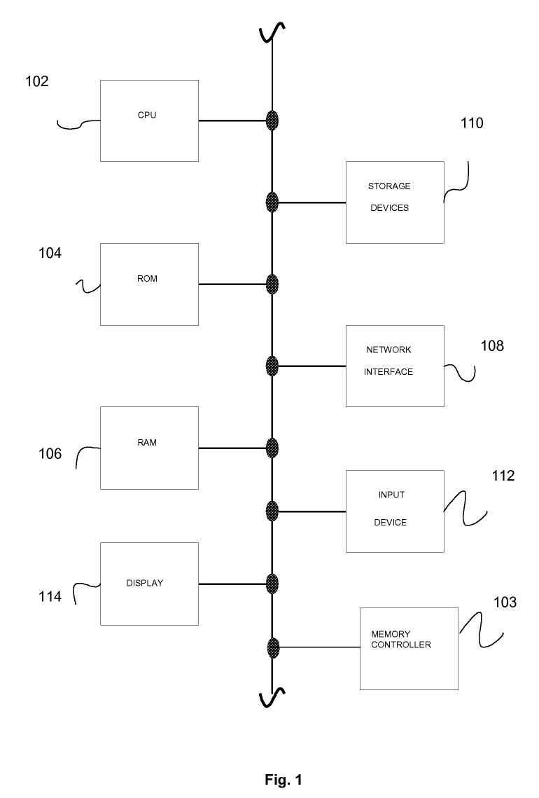

Referring now to FIG. 1, functional elements associated with an example computing device, such as an information processor or computer workstation is shown. The elements include one or more central processing units (CPU) 102 used to execute software code in order to control the operation of the computing device, one or more memory controllers 103, read only memory (ROM) 104, random access memory (RAM) 106, one or more network interfaces 108 to transmit and receive data to and from other computing devices across a communication network, storage devices 110 such as a full disk encryption hard disk drive, one or more input devices 112 such as a keyboard, mouse, track ball and the like, and a display 114. Preferably full disk encryption represents disk encryption to encrypt data that goes on a disk or disk volume, including the operating system and master boot record.

The various components of the computing device need not be physically contained within the same chassis or even located in a single location. For example, as explained above with respect to databases which can reside on storage device 110, storage device 110 may be located at a site which is remote from the remaining elements of information processors, and may even be connected to CPU 102 across a communication network via network interface 108.

The functional elements shown in FIG. 1 (designated by reference numbers 102-114) are preferably the same categories of functional elements preferably present in a device. However, not all elements need be present, for example, storage devices in the case of PDAs, and the capacities of the various elements are arranged to accommodate expected user demand. For example, CPU 102 in a user terminal may be of a smaller capacity than CPU 102 as present in a server computer. Similarly, it is likely that a server computer will include storage devices 110 of a much higher capacity than storage devices 110 present in a workstation. Of course, one of ordinary skill in the art will understand that the capacities of the functional elements can be adjusted as needed.

The nature of the present invention is such that one skilled in the art of writing computer executed code (software) can implement the described functions using one or more or a combination of a popular computer programming language including but not limited to C++, VISUAL BASIC, JAVA, ACTIVEX, HTML, XML, ASP, SOAP, and web application development environments. As used herein, references to displaying data on a computing device refer to the process of communicating data to the terminal across a communication network and processing the data such that the data can be viewed display 114.

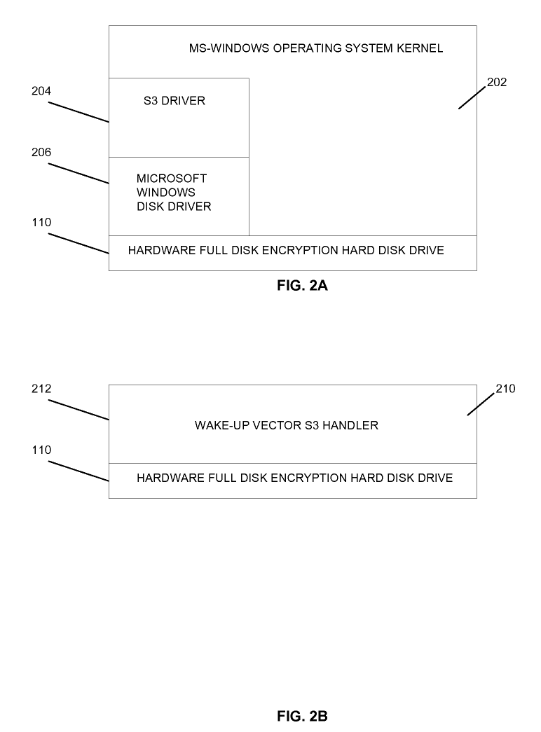

FIGS. 2A and 2B are block diagrams that illustrate example device driver stacks in accordance with two example alternative embodiments. In the example embodiment shown in FIG. 2A, a device driver is shown wherein a hook is provided into the operating system authentication process via the MICROSOFT WINDOWS or other suitable operating system kernel 202. Accordingly, a hook into a S3 sleep mode driver 204 and disk driver 206 is used to unlock a full disk encryption hard disk drive 110, in accordance with the teachings herein.

In this example embodiment, a system wake-up vector points to the native OS wake-up routine. As the native OS awakens from sleep it passes the wake-up message to the appropriate device drivers. A hardware device whose security context to be restored has hooked the appropriate driver in order to intercept and handle the wake-up message. In the example diagram, a hardware FDE HDD is transparently unlocked using memory resident credentials. This is provided for hardware devices that must be accessible whenever the native operating system is awake. The native operating system graphical user interface is then utilized to restrict access to the system. If the user fails to authenticate himself, then the hardware device can again be locked either deliberately or by allowing the system to again fall asleep as a result of user inaction.

In the alternative example embodiment shown in FIG. 2A, a device driver stack is shown wherein a hook into that is operable in connection with an embodiment that hooks into the operating system authentication process via the MICROSOFT WINDOWS or other suitable operating system kernel 202. Accordingly, a hook into a S3 sleep mode driver 204 and disk driver 206 is used to unlock a full disk encryption hard disk drive 110, in accordance with the teachings herein.

In one embodiment, a system wake-up vector is redirected to a device-specific S3 wake-up subroutine that handles a resume from S3 prior to allowing the call of the native OS wake-up vector. This S3 wake-up subroutine preferably challenges a user for authentication credentials or, alternatively, retrieve them from a hardware device such as a smartcard, as known. The supplied credentials are then used directly or to decrypt an unlock key from an encrypted key in memory. The unlock key is then be used immediately to unlock the hardware device or forwarded (“fed”) to the native OS for processing by a device driver capable of unlocking the hardware device.

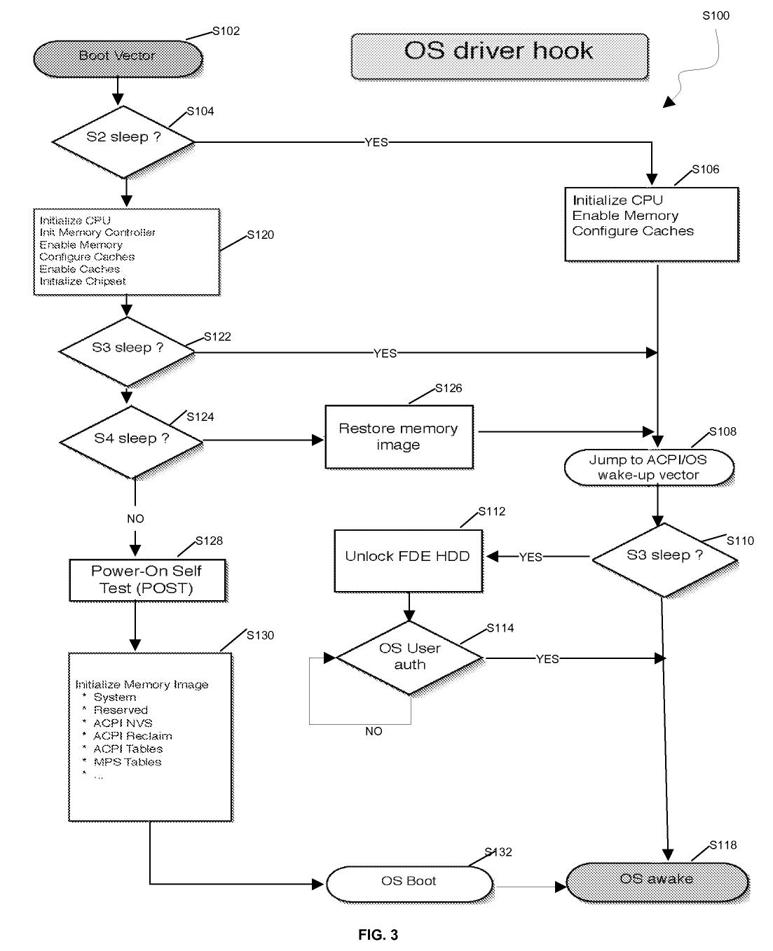

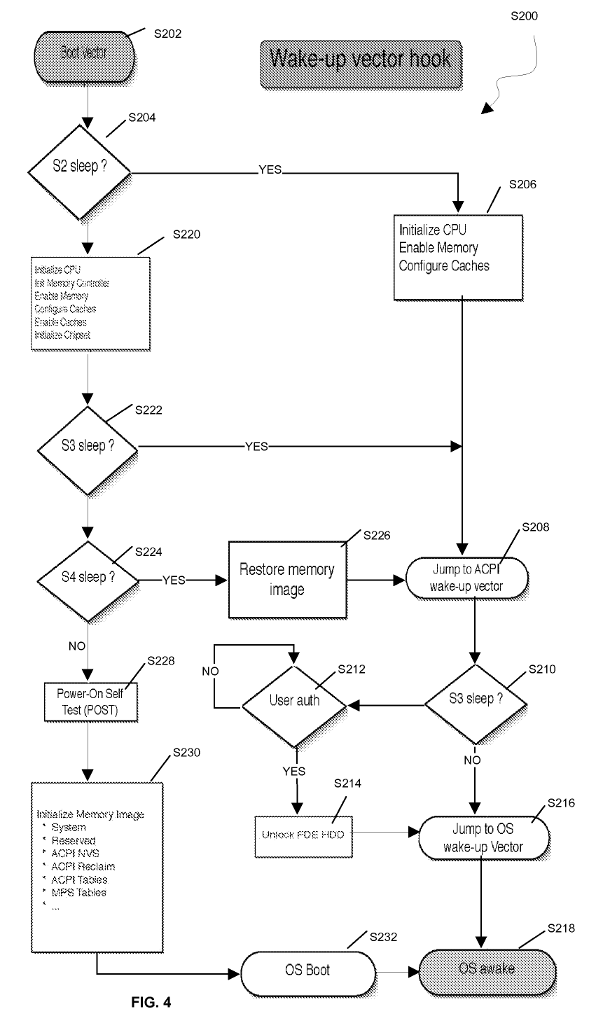

FIGS. 3 and 4 are flow charts that illustrate example steps associated with re-authenticating a user to provide access to an unlocked FDE hard disk drive (“HDD”) 110 in accordance with two example embodiments. Of course, one skilled in the art will recognize that the example steps S100 and S200 shown in FIGS. 3 and 4 are meant for purposes of illustration and that various alternatives can be made without departing from the spirit of the teachings herein. Moreover, reference is made to a device and the device's FDE HDD 110 in connection with the flow charts in FIGS. 3 and 4. In an example embodiment, the device represents a computer, such as a personal computer and the device's FDE HDD 110 is a storage device, such as a hard disk, installed in or with the computer. Of course, one skilled in the art will recognize that alternative hardware arrangements and devices are envisioned and applicable in accordance with the teachings herein.

Referring now to steps S100 associated with an embodiment that includes a hook into a native operating system driver shown in FIG. 3, at step S102, an initialization occurs via a boot vector. At step S102, the device may be at S2 sleep, S3 sleep, S4 sleep or initially powering on, as known in the art. Prior to steps S100 being executed, the device's hard disk drive 110 has been locked, a key has been generated and preferably obfuscated, as described above. At step S104, a determination is made whether the device is in S2 sleep. If the device is in S2 sleep, then, at step S106, CPU 102 is initialized, ROM 104 and/or RAM 106 are enabled and one or more caches are configured.

Continuing with reference to the flowchart shown in FIG. 3, the process continues to step 108 wherein an ACPI and/or operating system wake-up vector is invoked and, at step S110, a determination is made whether the device is operating at S3 sleep. If so, then at step S112, the device's FDE HDD 110 is unlocked, thereby enabling the native operating system's authentication process to be executed. As noted above, in order to prevent the device key from being easily located and used to unlock a device (e.g., a FDE HDD 110 in the example steps S100 of FIG. 3), the key is preferably obfuscated. Prior to the device's FDE HDD 110 being unlocked in step S112, the key is located and unobfuscated and thereafter used to retrieve and use the key to unlock the drive. Once the disk 110 is unlocked (in step S112), then, at step S114, the native operating system's authentication process is used to receive from the user credential information (e.g., user name and password). If the user is authenticated, then the process branches to step S118, and the operating system is awake and functional. If the user is not authenticated in step S114, then the process loops back to step S114.

Continuing with reference to the flowchart shown in FIG. 3, if the determination at step S104 that the device is not in S2 sleep, then the process branches to step S120, and CPU 102 is initialized, memory controller 103 is initialized, ROM 104 and/or RAM 106 are enabled, one or more caches are configured and enabled, and the device's chipset is initialized. Thereafter, the process branches to step S122 and a determination is made whether the device is in S3 sleep. If the device is in S3 sleep, then the process branches to step S108 and proceeds, as described above. Alternatively, if the determination in step S122 is that the device is not in S3 sleep, then the process branches to step S124 and a determination is made whether the device is in S4 sleep. If the device is in S4 sleep, then the process branches to step S126 and a memory image (initialized at step S130 and described below) is restored and the process branches to step S108, as described above.

Continuing with reference to the flowchart shown in FIG. 3, if the determination at step S124 that the device is not in S4 sleep, then the process branches to step S128 and a power-on self test (i.e., “POST”), as known in the art, occurs. Further, pre-boot authorization (“PBA”) preferably used to unlock the device's FDE HDD 110. Thereafter, the process branches to step S130 and a memory image is initialized that includes information representing the system, reserved, ACPI NVS, ACPI RECLAIM, ACPI Tables and MPS Tables, as known in the art, or the like is referenced. Thereafter, the process branches to step S132 and the operating system boots. Thereafter, the process branches to step S118, described above, and the operating system is awake and functional.

Thus as shown and described in connection with the embodiment of FIG. 3, a hook into a device's operating system is provided that enables a user to be authenticated upon an ACIP/OS wake-up vector call that temporarily unlocks the device's FDE HDD 110 and locks the FDE HDD 110 in the event that the user does not submit proper credentials.

FIG. 4 illustrates an alternative embodiment that includes steps S200 providing a hook to the ACPI wake-up vector, as opposed to a native operating system. Many of the steps associated with steps S200 are similar to those shown and described in connection with steps S100 (FIG. 3), however the authentication process does not require the device's FDE HDD 110 to be unlocked prior to authentication, and the device key that is obfuscated (and unobfuscated) in the embodiment described in FIG. 3 is encrypted in the embodiment described in FIG. 4.

At step S202, an initialization occurs via a boot vector. At step S202, the drive may be at S2 sleep, S3 sleep, S4 sleep or initially powering on, as known in the art. Prior to steps S200 being executed, the device's hard disk drive 110 has been locked and a key has been generated and encrypted, as described above. At step S204, a determination is made whether the device is in S2 sleep. If the device is in S2 sleep, then, at step S206, CPU 102 is initialized, ROM 104 and/or RAM 106 are enabled and one or more caches are configured.

Continuing with reference to the flowchart shown in FIG. 4, the process continues to step S208 wherein an ACPI and/or operating system wake-up vector is invoked and, at step S210, a determination is made whether the device is operating at S3 sleep. If so, then at step S212, an authentication process that preferably is provided via 16-bit code and that displays a data entry form for the user to submit credential information (e.g., user name and password) occurs. Alternatively, the authentication process obtains credential information from another source, such as a hardware device (e.g., smartcard). If the user is authenticated, the user's credentials are preferably hashed (or other used in another suitable way) to unencrypt the key (not shown) that is used by the native operating system to unlock the device's FDE HDD 110 (step S214). As noted above, the device's FDE HDD 110 is preferably unlocked after the device key is unencrypted. Once the disk 110 is unlocked (in step S214), then the process branches to step S216, and the operating system's wake-up vector is invoked to cause the operating system to be awake and functional (step S218). Alternatively, if the user is not authenticated after submitting credential information in step S212, then the process loops back to step S212 and the FDE HDD 210 remains locked.

Continuing with reference to the flowchart shown in FIG. 4, if the determination at step S204 that the device is not in S2 sleep, then the process branches to step S220, and CPU 102 is initialized, memory controller 103 is initialized, ROM 104 and/or RAM 106 are enabled, one or more caches are configured and enabled, and the device's chipset is initialized. Thereafter, the process branches to step S222 and a determination is made whether the device is in S3 sleep. If the device is in S3 sleep, then the process branches to step S208 and proceeds, as described above. Alternatively, if the determination in step S222 is that the device is not in S3 sleep, then the process branches to step S224 and a determination is made whether the device is in S4 sleep. If the device is in S4 sleep, then the process branches to step S226 and a memory image (initialized at step S230 and described below) is restored and the process branches to step S208, as described above.

Continuing with reference to the flowchart shown in FIG. 4, if the determination at step S224 that the device is not in S4 sleep, then the process branches to step S228 and a power-on self test (i.e., “POST”), as known in art, occurs. Further, pre-boot authorization (“PBA”) is preferably used to unlock the device's FDE HDD 110. Thereafter, the process continues to step S230 and a memory image is initialized that includes information representing the system, reserved, ACPI NVS, ACPI RECLAIM, ACPI Tables and MPS Tables or the like is referenced. Thereafter, the process branches to step S232 and the operating system boots. Thereafter, the process branches to step S218, described above, and the operating system is awake and functional.

Thus as shown and described in connection with the embodiment of FIG. 4, a hook into a device's firmware wake-up vector is provided that enables a user to be authenticated upon an ACIP wake-up vector call that ensures proper authentication is provided without a need to unlock the device's FDE HDD 110. Further, the key that unlocks the FDE HDD 110 is preferably encrypted and unencrypted, as necessary.

Although many of the examples herein relate to computer hard disk drives, is not limited to that particular configuration. It is contemplated that the teachings herein are applicable to many varieties of hardware devices, and that that any suitable operating system can be used, for example, WINDOWS 3.X, WINDOWS 95, WINDOWS 98, WINDOWS 2000, WINDOWS CE, WINDOWS NT, WINDOWS XP, WINDOWS VISTA, LINUX and any suitable PDA or palm computer operating system. Further, virtually any device that uses or has memory, i.e., network cards, video cards, sound cards, cellular telephones, etc. can benefit by the teachings herein.

Therefore, although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A method for providing secured access to a locked device, the method comprising:
unlocking the device a first time by using authentication that represents security credentials for accessing the device, thereby providing a security context;
losing the security context and locking the device; and
unlocking the device a second time using the authentication after the device loses the security context.

2. The method of claim 1, wherein the device loses the security context due to entering S1 sleep mode, S2 sleep mode, S3 sleep mode, S4 sleep mode or due to loss of power.

3. The method of claim 1, further comprising locking the device in case the security credentials are not appropriate for accessing the device.

4. The method of claim 1, further comprising prompting a user of the device for the authentication.

5. The method of claim 4, wherein the prompting includes unlocking the device and using an operating system authentication process.

6. The method of claim 5, further comprising locking the device in case the authentication received from the user from the operating system authentication process is not appropriate for accessing the device.

7. The method of claim 4, wherein the prompting includes displaying an data entry display form for receiving the authentication from the user without unlocking the device.

8. The method of claim 7, wherein the device is not unlocked in case the authentication received from the user is not appropriate for accessing the device.

9. The method of claim 1, wherein the device is unlocked with a first encryption key.

10. The method of claim 9, wherein the first encryption key is obfuscated.

11. The method of claim 9, further comprising generating a second encryption key and encrypting the first encryption key with the second encryption key.

12. The method of claim 11, further comprising decrypting the first encryption key with the second encryption key.

13. The method of claim 1, wherein the authentication is retrieved from a user, a hardware device, or a combination of a user and a hardware device.

14. A system for unlocking a device in a sleep mode, the system comprising:
a device operating system that includes an operating system wake-up routine when the device is taken out of the sleep mode;
a system wake-up vector operable with the operating system wake-up routine that provides a wake-up message for at least one device driver; and
an operating system driver hook that is operable to intercept the operating system wake-up message and unlock the device.

15. A system for unlocking a device in a sleep mode, the system comprising:
a system wake-up vector that is redirected to a wake-up subroutine prior to allowing a call to a native operating system wake-up vector, wherein the wake-up subroutine enables the device to wake from the sleep mode and retrieves authentication credentials; and
an unlock key operable to unlock the device.

16. The system of claim 15, wherein the wake-up subroutine retrieves the credentials from a user of the device or from a separate device.

17. The system of claim 15, wherein the unlock key is encrypted.

18. The system of claim 17, wherein the credentials are used to decrypt the unlock key.

19. The system of claim 15, wherein the unlock key is used to unlock the device or is transmitted to the operating system to be processed by a device driver that is operable to unlock the device.

20. The system of claim 15, wherein the authentication credentials are retrieved from a user, a hardware device, or a combination of a user and a hardware device.
